(19) United States
(12) Patent Application Publication
(10) Pub. No.: US 2006/0171481 A1
(43) Pub. Date: Aug. 3, 2006

(54) Method and apparatus for constructing MIMO constellations that preserve their geometric shape in fading channels

(75) Inventor: Dumitru Mihai Ionescu, Dallas, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/112,270

(22) Filed: Apr. 22, 2005

Related U.S. Application Data
(60) Provisional application No. 60/648,937, filed on Feb. 1, 2005.

(51) Int. Cl. H04L 1/02

(52) U.S. Cl. 375/267

(57) ABSTRACT

A method and related system of constructing multidimensional constellations whose shape remains invariant despite multiplicative distortions inherent to fading channels, and which provide a means for introducing coding redundancy to a signal without affecting the spectral efficiency of that signal is provided. Specifically, a method is provided for expanding multidimensional constellations, to enable coding redundancy without decreased spectral efficiency, in such a way as to guarantee that the shape will be preserved in fading.

### CROSS-REFERENCE TO PROVISIONAL APPLICATION

The present application claims priority from U.S. Provisional Application No. 60/648,937 filed Jan. 31, 2005, the contents of which are incorporated herein by reference in their entirety.

### FIELD OF THE INVENTION

The present invention relates generally to the communication of data upon a channel susceptible to quasistatic, or other, fading, such as a radio channel upon which data is transmitted during operation of a cellular communication system. More particularly, the present invention relates to a method, and an associated apparatus, to provide discernible constellation expansion of orthogonal code designs in order to produce coding gains in addition to diversity gains achieved using orthogonal designs.

### BACKGROUND OF THE INVENTION

Advancements in communication technologies have permitted the introduction, and widespread usage of, wireless communication systems. Cellular communication systems, as well as other types of multi-user, wireless communication systems, are regularly utilized by large numbers of consumers to communicate both voice and non-voice information. Current trends in 3.5G, 3.9G and 4G (respectively, generation three-and-a-half; three-point-nine, and four) systems aim at achieving high data rates at relatively low costs, and therefore mandate multicarrier designs, high spectral efficiencies, and Multiple Input, Multiple Output (MIMO) designs.

A communication system is formed, at a minimum, of a sending station and a receiving station interconnected by way of a communication channel. In a wireless communication system, the communication channel formed between the sending and receiving stations is formed of a radio channel defined upon a portion of the electromagnetic spectrum. Because a radio channel is utilized to form a communication link between the sending and receiving stations, a wired connection conventionally required in a wireline communication system is obviated. Use of a wireless communication system to communicate is permitted at, and between, locations at which the formation of a wireline connection would be impractical. Also, as the need for the wireline connection between the sending and receiving stations is obviated, the infrastructure costs associated with installation of a communication system rather than a conventional wireline communication system are reduced.

A cellular communication system is exemplary of a wireless, multi-user radio communication system. Cellular communication systems have been installed throughout wide geographical areas and have achieved wide levels of usage. A cellular communication system generally includes a fixed network infrastructure installed throughout the geographical area which is to be encompassed by the communication system. A plurality of fixed-site base stations are installed at selected positions throughout the geographical area. The fixed-site base stations are coupled, by way of additional portions of the network infrastructure to a public network, such as a PSTN (Public-Switched, Telephonic Network). Portable transceivers, referred to as mobile stations, communicate with the base stations by way of radio links.

Because of the spaced-apart positioning of the base stations, only relatively low-power signals are required to be generated by the mobile stations and by the base stations to effectuate communications there between. A cellular communication system, as a result, typically efficiently utilizes the portion of the electromagnetic spectrum allocated thereto upon which radio channels are defined. That is to say, because only low-power signals are required to be generated, the same radio channels can be reused at different locations throughout the geographical area encompassed by the communication system.

In an ideal communication system, a communication signal, when received at a receiving station, is substantially identical to the corresponding communication signal when transmitted by a sending station. However, in a non-ideal communication system in which the communication signal must be transmitted upon a non-ideal communication channel, the signal, when received at the receiving station, is dissimilar to the corresponding communication signal when sent by the sending station. Distortion of the communication signal caused during propagation of the communication signal causes such dissimilarities to result. If the distortion is significant, the informational content of the signal cannot accurately be recovered at the receiving station.

Fading caused by multi-path transmission, for instance Rayleigh fading, might alter the values of the information-bearing bits of the communication signal during its transmission upon the communication channel. Quasistatic flat fading, for example, models the situation when the fading is flat in frequency and is constant during the duration of a relevant block of transmitted symbols. In contrast, fast flat fading models the situation when the fading is flat in frequency but changes as fast as from a transmitted symbol epoch to the next. If the propagation distortion is not properly corrected, the communication quality levels of the communications are, at a minimum, reduced.

Various techniques are utilized to overcome distortions introduced upon a communication signal as a result of transmission over a non-ideal communication channel. These techniques include, for example, introducing coding redundancy in time, space and/or frequency prior to the signal's being transmitted across the non-ideal communication channel. These techniques, referred to collectively as Forward Error Correction (FEC) techniques, may be used individually or in any combination thereof. By increasing the coding redundancy of the signal, a coding gain is achieved and thereby the likelihood that the information content of the signal can be recovered once received at the receiving station is increased.

Another technique for overcoming distortions introduced by non-ideal communications channels is to create diversity. Diversity is created by introducing redundancy into the signal prior to its transmission, in a way that does not provide a coding gain but increases the rate of decrease in the probability of error as the signal to noise ratio increases. A typical drawback to both techniques, however, is a decrease in the spectral efficiency of the signal being transmitted. Spectral efficiency refers to the number of bits per use of a MIMO channel, or channel use, whereby one use of a MIMO channel having N transmit antennas comprises sending N complex symbols from the N transmit antennas. A need, therefore, exists for a means of achieving a coding gain while not decreasing the spectral efficiency of the transmitted signal.

Where data is being transmitted from a sending station over a communication channel, this data is originally in the form of a plurality of symbols, which may or may not be binary in nature. In order to utilize any one or all of the above described techniques for combating distortion, these symbols, or bits, must be applied to a channel encoder, which will encode the bits it receives to include any combination of time, space, frequency and/or coding redundancy. The output of this encoder, therefore, is a set of encoded bits or symbols representing the signal to be transmitted.

In order to transmit these encoded bits or symbols over a communication channel, they must first be mapped to an alphabet that can be recognized by the particular communication channel being used. For example, where a wireless channel is used, these encoded bits or symbols must be mapped to a set of complex numbers. In general, a mapper or router is used by a sending station to map the encoded bits or symbols and route them to the transmit antennas. In order to do so, the mapper uses a set of pre-constructed and stored constellation points, which may in certain instances be multidimensional, and which have been constructed to exhibit certain structural characteristics. These constellation points, collectively, make up a multidimensional constellation, which is a collection of constellation points representing symbols or points which are each multidimensional. In the instance where a wireless communication channel is being used, these multidimensional points may be realized as a set of complex numbers.

For instance, where multiple transmit antennas are used, and the structure of the multidimensional constellation, or set of individual constellation points, is orthogonal, each constellation point can be represented by a matrix, wherein each point of the matrix represents a complex dimension of the constellation point. For example, consider a constellation point that is represented by a 2×2 matrix, wherein each row represents an antenna from which the symbol(s) or bit(s) corresponding with that matrix or constellation point will be transmitted, and each column represents the time period, or epoch, within which the bit(s) or symbol(s) will be sent. In the case of a 2×2 matrix including space and time redundancy, a first antenna will transmit some symbol, and a function thereof, in two separate time epochs, and a second antenna will also transmit some symbol, and a function thereof, also in two separate time epochs, enabling the same symbol to be transmitted two times—i.e., creating both time and space redundancy.

These multidimensional constellations are often designed in such a way that the Euclidean distances and angles between constellation points within the multidimensional constellation, i.e., the shape of the multidimensional constellation, are in some way optimal. For instance, their design could center on ensuring that the minimum distance between constellation points is maximized, in order to facilitate the decoding of the signals transmitted. Alternatively, or additionally, these multidimensional constellations may be designed in such a way that they exhibit geometric uniformity. Geometric uniformity refers to the property whereby the multidimensional constellation is geometrically invariant. In other words, the Euclidean distance from any one (reference) constellation point to the rest of the constellation points in the multidimensional constellation is transparent to the reference point. Geometric uniformity is beneficial because where the set of distances from any one point to all the other points does not depend on a particular reference point, then the behavior of the signal is independent of what reference point is actually sent—i.e., the behavior of the signal is transparent to what constellation point one is sending.

However, these coding efforts will be lost where the communication channel over which the signal is being transmitted distorts the shape of the signal for a given instantaneous realization of the channel. In the instance where an AWGN (Additive White Gaussian Noise) channel is used, in which the only impairment is the linear addition of wideband Gaussian noise with a constant spectral density, any efforts to design a code centered on ensuring a certain Euclidean distance spectrum will be worthwhile because the AWGN channel will only add noise to the signal, it will not distort its shape. However, where a fading channel is used, because fading is a multiplicative distortion, which can move the points of a constellation (at least in the receiver's perspective), therefore changing the Euclidean distances between these points, these designing efforts may be lost. While it has been proven (See H. Schulze, “Geometrical Properties of Orthogonal Space-Time Codes,” IEEE Commun. Letters, vol. 7, pp. 64-66, January 2003; also, M. Gharavi-Alkhansari and A. B. Gershman, “Constellation Space Invariance of Orthogonal Space-Time Block Codes,” IEEE Trans. Inform. Theory, vol. 51, pp. 331-334, January 2005) that the shape of orthogonal multidimensional constellations are resilient to flat fading channels, mainly because such designs allow any constellation point to be expressed as a linear combination of basis matrices, such resilience is not guaranteed to remain upon the introduction of coding redundancy into the signal, even when coding redundancy does not affect the spectral efficiency of the signal.

It would therefore be desirable to provide a means of constructing multidimensional constellations capable of accommodating coding redundancy in the form of coding gain without sacrificing spectral efficiency, yet continuing to exhibit symmetries that can be preserved despite the multiplicative distortions inherent to a fading channel.

### BRIEF SUMMARY OF THE INVENTION

Generally described, embodiments of the present invention provide an improvement over the known prior art by providing a means for adding coding redundancy to a signal without affecting the spectral efficiency of the signal. In addition, embodiments of the present invention provide a further improvement over the known prior art by providing a means of constructing multidimensional constellations for transmission of the signal having coding redundancy, wherein the shape of the signal is preserved for any instantaneous channel realization, except for multiplication by a scaling factor, despite the transmission over a non-ideal, or fading, communications channel.

In accordance with one aspect of the present invention, a method of transmitting, from at least two antennas, a signal formed of a sequence of multidimensional points and having coding redundancy is provided. The first step of the method includes using a first set of multidimensional points, whereby each multidimensional point in the first set is capable of conveying a predefined number of bits over a specified number of channel uses, such that a signal with no coding redundancy and formed of the first set of multidimensional points exhibits a spectral efficiency of a predetermined number of bits per channel use and wherein the first set of multidimensional points forms an initial multidimensional constellation. The second step of the method includes expanding the initial multidimensional constellation to create an expanded multidimensional constellation in order to allow transmission of a signal with coding redundancy without reducing the spectral efficiency of the signal. The expanded multidimensional constellation is formed of a second set of multidimensional points, whereby each multidimensional point in said second set is capable of conveying a predefined number of bits over a specified number of channel uses, such that a signal with coding redundancy and formed of the second set of multidimensional points exhibits the same spectral efficiency as the signal with no coding redundancy formed of the first set of multidimensional points (unless additional puncturing and/or repetition is performed to modify the spectral efficiency). The second set of multidimensional points defines a shape in a relevant multidimensional space of the expanded multidimensional constellation, wherein the shape is preserved, except for multiplication by a scaling factor, when subject to instantaneous realizations of multiplicative distortions during transmission of the signal over a fading channel.

In one embodiment, the initial multidimensional constellation is orthogonal. In one embodiment, the initial multidimensional constellation is expanded by multiplying it by an appropriate unitary matrix U in order to generate the expanded multidimensional constellation.

According to one embodiment, each of the multidimensional points forming the expanded multidimensional constellation is positioned at a distance and at an angle with respect to all other multidimensional points forming the expanded multidimensional constellation. A combination of the distance and angle of each multidimensional point with respect to all other multidimensional points forming the expanded multidimensional constellation makes up a set of distance and angle pairs that defines the shape of the expanded multidimensional constellation. In one embodiment, the set of distance and angle pairs is the same for each constellation point within the expanded multidimensional constellation.

In one embodiment, each multidimensional point of the initial and expanded multidimensional constellations is represented by a matrix comprising one or more values. These values represent one or more dimensions of the multidimensional point, which correspond to one or more dimensions in which the predefined number of bits associated with that multidimensional point will be transmitted. In one embodiment, these dimensions include one or more of space, time and frequency, and in one embodiment, the one or more values of the matrix are complex in nature.

In accordance with another aspect of the present invention, a method of constructing a multidimensional constellation is provided. This method includes the steps of: (1) providing an initial multidimensional constellation formed of a first set of multidimensional points, each of the first set of multidimensional points capable of conveying a predefined number of bits over a specified number of channel uses, such that a first signal with no coding redundancy and formed of the first set of multidimensional points exhibits a spectral efficiency of a predetermined number of bits per channel use; and (2) expanding the initial multidimensional constellation to form an expanded multidimensional constellation formed of a second set of multidimensional points, each of the second set of multidimensional points capable of conveying a predefined number of bits over a specified number of channel uses, such that a second signal with coding redundancy and formed of the second set of multidimensional points exhibits the same spectral efficiency as the first signal with no coding redundancy and formed of the first set of multidimensional points, wherein the second set of multidimensional points defines a shape in a relevant multidimensional space of the expanded multidimensional constellation that is capable of being preserved, except for multiplication by a scaling factor, when subject to instantaneous realizations of multiplicative distortions during a transmission of the second signal over a fading channel.

In accordance with another aspect of the present invention, an apparatus for transmitting a signal having coding redundancy including a data source, a channel encoder, and a modulator is provided. The data source is configured to provide data to be transmitted by the signal, wherein the data comprises a first set of bits capable of being conveyed by a first set of multidimensional points, whereby each multidimensional point in the first set is capable of conveying a predefined number of bits over a specified number of channel uses, such that a signal formed of the first set of multidimensional points exhibits a spectral efficiency of a predetermined number of bits per channel use. The first set of multidimensional points forms an initial multidimensional constellation. The channel encoder is configured to receive the first set of bits from the data source and to introduce coding redundancy to the first set of bits. An output of the channel encoder is a second set of encoded bits that is larger than the first set of bits. The modulator is configured to then receive this second set of encoded bits and to map it to a second set of multidimensional points, whereby each multidimensional point in the second set is capable of conveying a predefined number of encoded bits over a specified number of channel uses, such that a signal formed of the second set of multidimensional points exhibits the same spectral efficiency as the signal formed of the first set of multidimensional points. This second set of multidimensional points forms an expanded multidimensional constellation having a shape in a relevant multidimensional space that is defined by the second set of multidimensional points and is preserved, except for multiplication by a scaling factor, when subject to instantaneous realizations of multiplicative distortions during transmission of the signal over a fading channel

In one embodiment, the channel encoder and the modulator are one element.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a communication system in which an embodiment of the present invention is operable;

FIG. 2 is a table illustrating 2×2 matrices along with relevant cosets and corresponding uncoded bits vs. number of states q, in accordance with one embodiment of the present invention; and

FIG. 3 illustrates indexing for 4PSK constellation points in accordance with one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the present invention provide a method for constructing multidimensional constellations whose shape remains invariant despite instantaneous distortions inherent to fading channels, and which provide a means for introducing coding redundancy to a signal without affecting the spectral efficiency of that signal. Specifically, embodiments of the present invention provide a method of expanding multidimensional constellations, to enable coding redundancy without decreased spectral efficiency, in such a way as to guarantee that the shape will be preserved in fading.

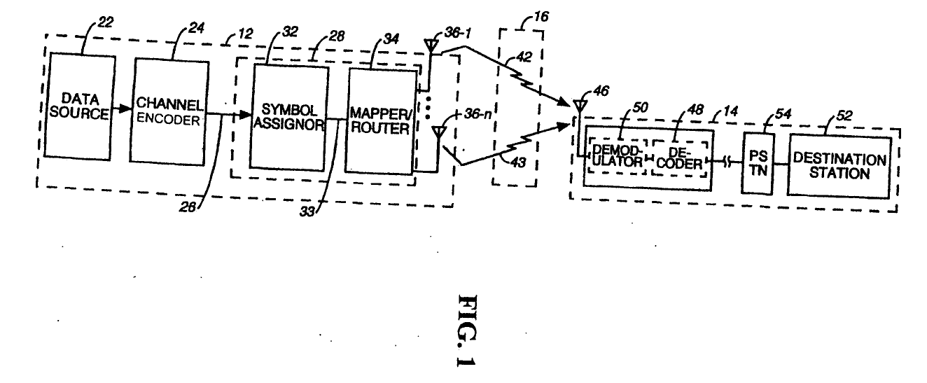

FIG. 1 illustrates a communications system 10 operable to communicate data according to an embodiment of the present invention between a sending station 12 and a receiving station 14 by way of a communication channel 16. This communication system 10 may, for example, comprise a wireless communications system, such as a cellular communication system. Alternatively, the communications system may be wired. The sending station 12 uses at least two transmit antennas 31-1-36-Lₜ. Likewise, the receiving station 14 uses at least one receive antenna 46. The communication channel 16 is susceptible to fading, requiring channel encoding across all transmit antennas 31-1-36-Lₜ. For example, the channel 16 may exhibit quasistatic fading, or fading that remains constant over a block of channel epochs (or uses). A wireless channel with multi-path propagation is sometimes referred to as a fading channel.

In one embodiment, the sending station 12 includes a data source 22. This data source 22 is the source of the data to be communicated by the sending station 12 to the receiving station 14. The data source 22 may, for example, comprise voice data generated by a user of a mobile station of which the sending station 12 is a part. The data source 22 may also represent non-voice data, such as that generated by a processing device. When a voice signal forms the data generated by the data source 22, the appropriate processing circuitry, e.g., for source encoding, not shown, is used to convert the voice signal into digital form.

The data generated by the data source 22 is applied to a channel encoder 24, which encodes the data applied thereto according to a selected encoding scheme. This encoding scheme may, for example, encode the data in order to increase the information's redundancy in time (i.e., create time diversity). Alternatively, or additionally, the channel encoder 24 may encode the data to increase the information's redundancy in space and/or frequency, or generally to introduce coding redundancy into the signal. The channel encoder 24 generates encoder output symbols, which can then be applied to a modulator 28 on line 26. Each encoder output symbol formed by the channel encoder 24 occupies a time period, herein referred to as the channel encoder output symbol epoch. Each encoder output symbol may further indicate on which antenna and/or at which frequency the encoder output symbol will be transmitted—i.e., the encoder output symbol may be multidimensional in nature.

The modulator 28, to which the encoder output symbols are applied, comprises at least a symbol assignor 32 and a mapper or router 34. After one or more encoder output symbols is applied to the modulator 28, exactly one multidimensional constellation point is selected for simultaneous transmission, from all antennas, of values from each of the signal constellations pertaining to all of the transmit antennas 36-1-36-Lₜ in each symbol epoch. The selection is indicated via indices that point to the appropriate modulation parameter values, according to the corresponding modulation schemes used by all of the transmit antennas 36-1-36-Lₜ. For example, where a QPSK (Quaternary Phase Shift Keying) modulation scheme is used, the correct number of encoder output symbols is assigned, per transmission, to one of four constellation points defined in the QPSK constellation.

As stated above, constellation points correspond to individual bits or encoded symbols being transmitted. These bits or encoded symbols are often multidimensional—i.e., they are often being transmitted at multiple time periods, over multiple antennas and/or at multiple frequencies. As a result, each multidimensional constellation point corresponding to a multidimensional bit or encoded symbol can, in one embodiment, be represented by a matrix made up of two-dimensional (i.e., complex) values, i.e., points indicating, for example, on which antennas or at which symbol epochs the corresponding symbol will be transmitted. In the case of a wireless communication channel, these dimensional values are complex in nature. A set of multidimensional constellation points makes up and defines the shape or geometric structure of a multidimensional constellation. As discussed in detail below, these multidimensional constellations are carefully designed with particular attention paid to their shape, i.e., with particular attention paid to the Euclidean distances and angles between each multidimensional constellation point. These carefully designed multidimensional constellations can then be stored within the sending station 12 such that the modulator 28 can access these multidimensional constellation points when mapping the encoder output symbols. The design of these multidimensional constellations is important to the overall quality of the signal being transmitted. An important feature of this invention, therefore, is constructing these multidimensional constellations, of correct cardinality, to be stored in the sending station 12 and accessed by the modulator 28; this includes expansion of some initial orthogonal constellation, which may have additional structure such as geometrical uniformity.

The modulator symbols to which the encoder output symbols are assigned are applied to the mapper/router 34. In one embodiment of the present invention, the mapper 34 operates to map the symbols applied thereto to a set of two or more antenna transducers 36-1-36-Lₜ. In the implementation shown in FIG. 1, the set of antenna transducers include Lₜ antenna transducers 36-1-36-Lₜ. In this embodiment, the mapper 34 consists of a serial-to-parallel converter, which converts a serial symbol stream applied thereto into parallel output symbols for application to the antenna transducers 36-1-36-Lₜ. The mapper 34 is operable to map selected ones of the symbols applied thereto through corresponding selected ones of the antenna transducers 36-1-36-Lₜ. Conventional sending-station circuitry positioned between the modulator 28 and the antenna transducers 36-1-36-Lₜ, such as amplification elements and up-conversion elements, are not shown in FIG. 1 for purposes of simplicity.

Each antenna transducer 36-1-36-Lₜ is operable to transduce, into electromagnetic form, the symbols provided thereto, thereby to transmit the symbols upon the communication channel 16 to the receiving station 14. FIG. 1 illustrates two links 42, 43, which in turn represent multiple paths conveying electromagnetic signals to the receiving station 14. Because of these multiple, distinct transmission paths present in the links 42, 43 that convey the communications signals, the signal from each antenna transducer 36-1-36-Lₜ is susceptible to fading. The fading experienced by the signals from different antenna transducers 36-1-36-Lₜ lacks mutual correlation; that is to say, the fading process affecting the signals from different antenna transducers 36-1-36-Lₜ are uncorrelated with one another.

The signals transmitted upon the paths 42, 43 are sensed by an antenna transducer 46, which forms a portion of the receiving station 14. In one embodiment, a single receiving antenna transducer 46 is used. Alternatively, the receiving station 14 may include more than one antenna transducer 46. The antenna transducer 46 converts the electromagnetic signals received thereat into electrical form and provides the electrical signals to the receiver circuitry of the receive portion of the receiving station 14. The receive portion includes a demodulator 50, which performs demodulation operations in a manner operable generally reverse to that of the channel encoder 24. Demodulated symbols are then applied to a decoder 48, which decodes the demodulated symbols applied thereto in a manner operable generally reverse of the channel encoder 24. In one embodiment, the decoder 48 and demodulator 50 are combined, and a joint demodulation and decoding operation is performed; alternatively iterations may be performed between demodulator and decoder.

Additional circuitry of the receiving station 14 is not separately shown and is conventional in nature. In one embodiment, the receiving station 14 forms the receive portion of a base station system. In this embodiment, once the signal is operated upon by the receiving station 14, representative signals are provided to a destination station 52 by way of a PSTN (Public-Switch Telephone Network) 54.

As stated above, where signals are transmitted over a non-ideal communication channel, such as one subject to fading, these signals can become distorted causing the information they are transmitting to be altered or even lost. Various techniques are utilized to compensate for this distortion, such as time, space, frequency and coding diversity, and/or designing signals in such a way that they have optimal Euclidean distance spectra. Embodiments of the present invention deal with two major issues underlying these techniques. The first is the fact that when dealing with typical multidimensional constellations, which are known in the art, the addition of coding redundancy (i.e., the creation of coding diversity in order to combat distortion) causes the spectral efficiency, or number of bits per channel use, of the signal to go down. The second issue underlying distortion-combating techniques is that unless care is taken to select multidimensional constellations whose shape is invariant when transmitted over a fading, or otherwise non-ideal, communication channel, all efforts at designing a signal with an optimal Euclidean spectrum will be lost.

Embodiments of the present invention, therefore, provide a means of constructing multidimensional constellations to be stored in a sending station 12 and accessed by a modulator 28 when mapping encoder output symbols, whose shape remains invariant to the distortions inherent to fading channels, and whose spectral efficiency does not decrease, despite the introduction of coding redundancy. In particular, embodiments of the present invention provide a method of expanding multidimensional constellations in such a way as to guarantee that the shape of the constellation will be preserved in fading, for any instantaneous realization of a flat fading channel.

In order to expand the multidimensional constellation, so that coding redundancy can be introduced without affecting spectral efficiency (unless additional puncturing and/or repetition is deliberately introduced in order to modify the spectral efficiency), and in such a way as to guarantee that the shape of the multidimensional constellation will be preserved in fading, the constellation must be manipulated using a carefully selected matrix U as herein described. For exemplary purposes only, the description below relates to multidimensional space-time constellations. As discussed above, however, these multidimensional constellations may comprise complex numbers representing any combination of time, space and/or frequency.

### A. Fading Resilience via Geometrically Invariant Properties

The geometric invariance of the multidimensional constellation and the resulting fading resilience will be described mathematically herein below. Let i=\sqrt{−1} and consider a linearly decodable, complex, linear, generalized orthogonal design O of rate K/T, which maps a vector

$$s {=}^{def} {[ {z}_{1} , … , {z}_{K} ]}^{T} ∈ {C}^{K}$$

of K complex symbols

$${z}_{k} {=}^{def} {x}_{k} + {iy}_{k} , k = 0 , … , K - 1 ,$$

to semiunitary complex T×N matrices SεM_{T,N}(C), where T is the number of channel uses (symbol epochs). Semiunitarity means that S^{H}S=∥s∥²I_{N} (even when T≢N), and the linearly decodable assumption leads, in one aspect, to the constraint T≧N. The constraint T≧N can be dropped if one considers symbols that are not linearly decodable. In another aspect, pursuant to the isometry I: C^{K}→R^{2K} that maps any SεC^{K} to the 2K-dimensional real vector

$$χ {=}^{def} {[ ℜ \{ {z}_{1} \} , 𝔍 \{ {z}_{1} \} , … , ℜ \{ {z}_{K} \} , 𝔍 \{ {z}_{K} \} ]}^{T} = I ( s ) ,$$

linearity in the arbitrary symbols zₖ, k=0, . . . , K−1, means that there exist 2K basis matrices of size T×N, with complex elements, such that

$$\begin{matrix}S = {\sum }_{l = 0}^{2 K - 1} {χ}_{l} {β}_{l} ∈ O , ∀ χ ∈ {R}^{2 K} & ( 1 ) \\ = {\sum }_{l = 1}^{K} ( {x}_{l} {β}_{2 l - 2} + {y}_{l} {β}_{2 l - 1} ) = {\sum }_{l = 1}^{K} ( {z}_{l} {β}_{l}^{-} + {z}_{l}^{*} {β}_{l}^{+} ) , & ( 2 )\end{matrix}$$

where the asterisk represents complex conjunction, wherein

$${β}_{l}^{\pm } = \frac{1}{2} ( {β}_{2 l - 2} \pm i {β}_{2 l - 1} ) ; \qquad ( 3 )$$

and wherein a necessary and sufficient condition for S^{H}S=∥s∥² I_{N} is
βₗ^{H}βₚ+βₚ^{H}βₗ=2δₗₚI_{N}, l, p=0, . . . 2K−1, (4)
where I_{N} is the N×N identity matrix. See, for example, O. Tirkkonen and A. Hottinen, “Square-matrix embeddable space-time block codes for complex signal constellations,” IEEE Trans. Inform. Theory, vol. 48, pp. 384-395, February 2002 (hereinafter “Tirkkonen, et al.”).

The rate K/T mentioned above represents only a symbol rate, which does not indicate in any way a (finite) spectral efficiency-unless the complex symbols are restricted to a common finite constellation Q such as m-PSK, with m some integer power of 2; in other words, the complex symbols zₖ's (or the real 2K -tuple χ) can assume arbitrary complex (real) values (O is non-countable).

As long as ΩεR^{2K}, the set O spanned by the basis {β₁}ₗ₌₀^{2K-1} over R is a vector space. Specifying a (finite) spectral efficiency means, e.g., restricting the complex symbols zₖ, k=0, . . . , K−1, to a common finite constellation Q, e.g. m-PSK; this will produce a multidimensional space-time constellation with a finite cardinality, denoted G⊂O in the sequel, which in general is no longer a vector space but a module; nevertheless, eqs. (1) and (4) still hold because Q⊂C and, respectively, because restricting zₖ, k=0, . . . , K−1, to Q does not modify the basis expansion in O. Note that (1), (4) directly lead to
(−S′)^{H}(S−S′)=∥χ−χ′∥²I_{N}, ∀S,S′εO. (5)
Since the complex Radon-Hurwitz eqs. (4) are invariant to multiplication of all matrices in a generator set by ζεC,∥ζ∥=1, it follows that {βₗ}ₗ₌₀^{2K-1} is a basis in O if and only if {βₗζ}ₗ₌₀^{2k-1} is.

An expansion (see below) of the finite space-time constellation G—as practiced, e.g., in D. M. Ionescu, K. K. Mukkavilli, Z. Yan, and J. Lilleberg, “Improved 8- and 16-State Space-Time codes for 4PSK with Two Transmit Antennas,” IEEE Commun. Letters, vol. 5, pp. 301-303, July 2001 (hereinafter “Ionescu, et al.”); S. Siwamogsatham and M. P. Fitz, “Improved High-Rate Space-Time Codes via Concatenation of Expanded Orthogonal Block Code and M-TCM,” 2002; S. Siwamogsatham and M. P. Fitz, “Improved High-Rate Space-Time Codes via Orthogonality and Set Partitioning,” 2002; N. Seshadri and H. Jafarkhani, “Super-Orthogonal Space-Time Trellis Codes,” Proc. ICC '02, May 2002, Vol. 3, pp. 1439-1443 (hereinafter “Seshadri, et al.”); and H. Jafarkhani, N. Seshadri, “Super-orthogonal space-time trellis codes,” IEEE Trans. Inform. Theory, vol. 49, pp. 937-950, April 2003 (hereinafter “Jafarkhani, et al.”)—does not necessarily remain within the limits of the generalized orthogonal design O, and orthogonality of pairwise differences (see Z. Yan and D. M. Ionescu, “Geometrical Uniformity of a Class of Space-Time Trellis Codes,” IEEE Trans. Inform. Theory, vol. 50, pp. 3343-3347, December 2004. (hereinafter “Yan, et al.”)) is not necessarily preserved in the expanded constellation.

1. Constellation Expansion and Their Properties

As mentioned above, adding coding redundancy without modifying the spectral efficiency requires that the finite space-time constellation be extended beyond the set G of orthogonal matrices. Consider a multidimensional space-time constellation G from a generalized complex orthogonal design O, and an expansion of G via a symmetry or by multiplication by some unitary N×N matrix U. A first-tier expanded constellation is

$${G}_{e} {=}^{def} G ⋃ GU . \qquad ( 6 )$$

and has been introduced in Ionescu, et al. Specifically, with a 4PSK constellation on each of N=2 transmit antennas, Ionescu, et al. used a symmetry operation (characterized further in Yan, et al.) to expand an orthogonal set of sixteen matrices obtained by mapping all K-tuples of 4PSK elements to T×N matrices, where K=T=2; after expansion, pairwise differences are in general non-orthogonal (no longer verify (5)), and the symmetry operation used in Ionescu, et al. corresponds to right multiplication by the unitary matrix

$$[ \begin{matrix}1 & 0 \\ 0 & - 1\end{matrix} ]$$

—recognized to be a particular case of the ‘super-orthogonal’ construction from Seshadri et al. and Jafarkhani, et al. Note that any symmetry can be described as multiplication by a unitary matrix of appropriate size.

Whenever the intention is to guarantee some geometrical invariance property of the expanded constellation Gₑ, one advantageous method for expanding G may be some symmetry operation, rather than an arbitrary unitary transformation—which, in turn, should arise simply as a consequence of the symmetry itself; the reason is, of course, the very nature of the expected result, which is some form of geometrical invariance.

As already noted, GU [symbol] O, in general, because GU is not necessarily in the span of {β′ₗ}ₗ₌₀^{2K-1} thereby, orthogonality of pairwise differences after a constellation expansion that does not alter the spectral efficiency will be lost. Nevertheless, if SεG, then (SU)^{H}SU=∥s∥² I_{N} and
SU=Σₗ₌₀^{2K-1}χₗβ′ₗ, ∀χεR^{2K} (7)
β′ₗ=βₗU, ∀l=0, . . . , 2K−1 (8)
As discussed above (see Tirkkonen, et al.), {βₗ}ₗ₌₀^{2k-1} verify the complex Radon-Hurwitz eqs. (4), while {β′ₗ}ₗ₌₀^{2K-1} verify
β′ₗ^{H}β′ₚ+β′ₚ^{H}β′ₗ=2δₗₚI_{N}, l,p=0, . . . , 2K−1; (9)
however, a similar property does not necessarily hold for two basis matrices from the different sets {βₗ}ₗ₌₀^{2K-1}, {β′ₗ}ₗ₌₀^{2K-1}.

Since U is unitary if and only if Uζ is unitary—provided that ζεC, |ζ|=1—expansions via Uζ and U should be simultaneously characterizable as applying U to either Gζ or G.

As proof, let QεC be a (finite) complex constellation, and {βₗ}ₗ₌₀^{2K-1} be a generator set for G⊂O over I(Q^{K}), such that any SεG verifies (1), (2) with zₖεQ. Let ζεC, |ζ|=1. Then

$$\begin{matrix}\tilde{G} {=}^{def} G ζ = \{ \tilde{S} {=}^{def} S ζ \text{\vert} S ∈ G \} ⋐ O , & ( 10 ) \\ \tilde{S} = {\sum }_{l = 1}^{K} [ ℜ \{ {z}_{l} ζ \} {η}_{2 l - 2} + 𝔍 \{ {z}_{l} ζ \} {η}_{2 l - 1} ] , & ( 11 ) \\ \tilde{S} = {\sum }_{l = 1}^{K} [ {\tilde{x}}_{l} {η}_{2 l - 2} + {\tilde{y}}_{l} {η}_{2 l - 1} ] , {\tilde{x}}_{l} + i {\tilde{y}}_{l} {=}^{def} {\tilde{z}}_{l} ∈ Q ζ , & ( 12 ) \\ {η}_{2 l - 2} {=}^{def} ζ ( ℜ \{ ζ \} {β}_{2 l - 2} - 𝔍 \{ ζ \} {β}_{2 l - 1} ) , l = 1 , … , K , & ( 13 ) \\ {η}_{2 l - 1} {=}^{def} ζ ( ℜ \{ ζ \} {β}_{2 l - 1} + 𝔍 \{ ζ \} {β}_{2 l - 2} ) , l = 1 , … , K . & ( 14 )\end{matrix}$$

Moreover, {ηₗ}ₗ₌₀^{@k-1}⊂O and
ηₗ^{H}ηₚ+ηₚ^{H}ηₗ=2εₗₚI_{N},l,p=0, . . . , 2K−1 (15)

A sketch of proof is as follows. The fact that {ηₗ}ₗ₌₀^{2K-1}⊂O is obvious, while simple manipulations of (13), (14), (4) prove (15) directly. To prove (11) it suffices to re-write the terms in the second summation of (2) as zₗβₗ⁻+zₗ^{*}βₗ⁺=zₗζζ^{*}βₗ⁻+zₗ^{*}ζ^{*}ζ^{*}βₗ⁺=(zₗζ)ηₗ⁻+(zₗζ)^{*}ηₗ⁺, where ηₗ⁺=βₗ⁺ζ and ηₗ⁻ζ, followed by straightforward manipulations and by finally multiplying (2) by ζ.

It has also been shown that an expansion of G by Gζ=G(ζI_{N}) simply changes the generator set and the alphabet (from Q to Qζ), and is indiscernible (from O) in the sense that Gζ⊂O. Therefore expansions of the form Gₑ=G∪GUζ differ from those of the form Gₑ=G∪GU only in that U operates on a different subset of O(Gζ vs. G). Clearly, ζεC, |ζ|=1 preserves the constellation energy.

If ζεC, |ζ|=1, ζ≢1, and U≢I_{N} is a N×N unitary matrix, then a first-tier, indirect (direct), discernible constellation expansion of G is Gₑ=G∪GUζ(Gₑ=G∪GU), where GUζ≢G(GU≢G) and U has either more than two distinct eigenvalues, or all real eigen values. This accommodates constellation expansion by a unitary (not necessarily Hermitian) matrix that has complex eigenvalues, but only arising as a rotation of a set of real eigenvalues.

Consider a direct discernible constellation expansion of G to G∪GU, where matrices S, SU verify (1), (7) ∀SεG. If Gₑ of (6) is a first-tier, direct, discernible expansion by U≢±I_{N} of a multidimensional space-time constellation G from a generalized complex orthogonal design, having a generator set {βₗ}ₗ₌₀^{K-1}, and if {β′ₗ}ₗ₌₀^{2K-1} is the generator set for

$${G}^{′} {=}^{def} GU$$

that verifies (8), then no element of the set {β′ₗ}ₗ₌₀^{2K-1} is a linear combination, over R, of the matrices βₗ, l=0, . . . , 2K−1.

A sketch of the proof is as follows. Assume to the contrary that β′_{q}_{₀}=β_{q}_{₀}U=Σ_{q=0}^{2K-1}t_{q}β_{q}, where

$$t {=}^{def} {[ {t}_{0} , … , {t}_{2 K - 1} ]}^{T} ∈ {R}^{2 K} .$$

It can be easily verified, using (9), that Σ_{q=0}^{2K-1}t_{q}²=1. First, assume that at least two components of t are nonzero. Then, for some nonzero t_{q}_{₁}, q₁≢q₀, β_{q}_{₁}=t_{q}_{₁}⁻¹β_{q}_{₀}U−t_{q}_{₁}⁻¹Σ_{q≢q}_{₁}_{,q}_{₀}t_{q}β_{q}−t_{q}_{₀}t_{q}_{₁}⁻¹β_{q}_{₀}. From (4), β_{q}_{₁}^{H}β_{q}_{₀}+β_{q}_{₀}^{H}β_{q}_{₁}=0, which can be reduced after straightforward manipulations to t_{q}_{₁}⁻¹U^{H}β_{q}_{₀}^{Hβ}_{q}_{₀}−t_{q}_{₁}⁻¹Σ_{q≢q}_{₁}_{,q}_{₀}t_{q}(β_{q}^{H}β_{q}_{₀}+β_{q}_{₀}^{H}β_{q})−2t_{q}_{₀}t_{q}_{₁}⁻¹β_{q}_{₀}^{H}β_{q}_{₀}U=0, or, after using (4), t_{q}_{₁}⁻¹U^{H}−2t_{q}_{₀}t_{q}_{₁}⁻¹I+t_{q}_{₁}⁻¹U=0. Then U^{H}=2t_{q}_{₀}I−U, and unitarity of U translates into U verifying the equation
U²−2t_{q}_{₀}U+I=0. (16)
Assume that U verifies a (monic) polynomial equation of degree smaller than two, namely U+m₀I=0; then, U=−m₀I, and unitarity together with the assumption that U has real eigenvalues imply that U=±I_{N}, which contradicts the hypothesis. Then, necessarily, (16) is the minimum equation of U. But t²−2t_{q}_{₀}t+1=0 has roots t^{(1),(2)}=t_{q}_{₀}±\sqrt{t_{q}_{₀}²−1}, with t_{q}<1; thereby, since the irreducible (in C, in this case) factors of the minimum polynomial divide the characteristic polynomial, it follows that the distinct eigenvalues of U are the distinct roots among {t⁽¹⁾,t⁽²⁾}, which do have, indeed, unit magnitude, but nonzero imaginary parts-again contradicting the hypothesis. Finally, assume that only one component of t is nonzero, say β′_{q}_{₀}=β_{q}_{₀}U=β_{q}_{₁}, q₁≢q₀. Then (4) is equivalent to U^{H}+U=0⇄U²+I=0, and the minimal polynomial t²+1=0 has non-real roots ±i—again contradicting the hypothesis.

Since Gζ⊂O, as discussed above, a similar contradiction as the one used above can be employed to infer directly that if Gₑ=G∪GUζ is a discernible expansion then (Gₑ\G)∩O={0}. Thereby, the above theorem leads directly to a direct sum structure since any discernible expanded constellation Gₑ is naturally embedded in a direct sum of two 2K-dimensional vector sub-spaces of M_{T,N}(C), and
S=Σₗ₌₀^{2K-1}χₗβₗ+Σₗ₌₀^{2K-1}χ′ₗβ′ₗ, ∀SεGₑ. (17)
2. Implications of Discernible Constellation Expansions

In all cases where the Euclidean distance between points from the multidimensional constellation Gₑ is relevant (see H.-F. Lu, Y. Wang, P. V. Kumar, and K. M. Chugg, “Remarks on Space-Time Codes Including a New Lower Bound and an Improved Code,” IEEE Trans. Inform. Theory, vol. 49, No. 10, pp. 2752-2757, October 2003; E. Biglieri, G. Taricco, A. Tulino, “Performance of space-time codes for a large number of antennas,” IEEE Trans. Inform. Theory, vol. 48, pp. 1794-1803, July 2002; D. M. Ionescu, “On Space-Time Code Design,” IEEE Trans. Wireless Commun., vol. 2, pp. 20-28, January 2003; and Yan, et al.), the Euclidean, or Frobenius, norm of SεGₑ is important; then, S can be identified via an isometry with a vector from R^{2TN}, where 2TN is the total number of real coordinates in S when using the expanded constellation Gₑ. Therefore, since SεGₑ is completely described by the 2·2·K real coordinates of the embedding space (see (17)), it follows that the first tier expansion uses 4K of the available 2TN diversity degrees of freedom. Note that, since when N≧2 the maximum rate for square matrix embeddable space-time block codes (unitary designs) is at most one (see Tirkkonen, et al., Theorem 1), it follows that K≦T and the dimensionality condition implicit in (17) is well-defined.

3. Fading Resilience

In order to show that Gₑ=G∪GU is resilient to flat fading, assume that a symbol matrix cεGₑ, is selected for transmission from the N transmit antennas during T time epochs; an arbitrary element of Gₑ (denoted S in above paragraphs) verifies (17), and either the χₖ coefficients or the χ′ₖ coefficients vanish. Without loss of generality, assume there is one receive antenna. Clearly, the symbol matrix selected for transmission verifies either cεG or cεGₑ\G; assume first the former, i.e. all χ′ₖ coefficients vanish. The observation vector during the T time epochs is given by
r=ch+n_{c}
where h=[h₁h₂ . . . h_{N}]^{T} is the vector of complex multiplicative fading coefficients and n_{c} is complex AWGN with variance σ²=N₀/2 in each real dimension. Given h and n_{c}, when χ′ₖ's are all zeros, the received vector is simply
r=Σₖ₌₀^{2k-1}χₖηₖ+n_{c}
ηₖ=βₖh for k=0,1, . . . , 2K−1. By eq. (4), it can be shown that z,901 {<ηₖ, ηₗ>}=∥h∥²δₖₗ. Define gₖ as the real vector corresponding to ηₖ as follows:
ηₖ⇄∥h∥gₖ for k=0,1, . . . , 2K−1,
where ⇄ denotes the correspondence between complex and real vectors. Clearly, gₖ's are real orthonormal vectors. Also define the real vectors corresponding to r and n_{c} respectively as follows: r⇄y and n_{c}⇄n. Then, the received real vector
y=μh∥Σₖ₌₀^{2K-1}χₖgₖ+n.
Define G=[g₀g₁ . . . g_{2K-1}], χ=[χ₀. . . χ_{2K-1}]^{T}; then
y=∥h∥G_{χ}+n.
Similarly, when cεGₑ\G, i.e. all χₖ's in (17) vanish, the following equation holds:
y′=∥h∥Σₖ₌₀^{2K-1}χ′ₖg′ₖ+n′
where r⇄y′ and β′ₖh⇄∥h∥g′ₖ. That is,
y′=∥h∥G′χ′+n′
where G′=[g′₀g′₁. . . g′_{2K-1}], χ′=[χ′₀χ′₁ . . . χ′₂ₖ₋₁]^{T}. Conditioned on whether the transmitted signal point is selected from G or from Gₑ\G, one can first define χ_{\textcircled{+}}=[χ^{T}χ′^{T}]^{T}, n_{\textcircled{+}}=[n^{T}n′^{T}]^{T}, and y_{\textcircled{+}}=[y^{T}y′^{T}]^{T}, where either half of the real coefficients vanish, then express the received signal in both cases as
y_{\textcircled{+}}=∥h∥G_{\textcircled{+}}χ_{\textcircled{+}}+n_{\textcircled{+}} (18)
where G_{\textcircled{+}} is the 2·2·T×2·2·K matrix

$$[ \begin{matrix}G & 0 \\ 0 & {G}^{′}\end{matrix} ]$$

It is easy to verify that G_{\textcircled{+}}^{T}G_{\textcircled{+}}=I_{2·2·K}. Hence, y_{\textcircled{+}} preserves the distances and angles of χ_{\textcircled{+}}—up to the scaling factor ∥h∥ and noise.

A final discussion pertains to the side information on whether the transmitted signal point belongs to G or Gₑ\G:
1. Representing the multidimensional points in Gₑ—and their respective Euclidean distances—in terms of vectors coordinates (χₖ, χ′ₖ) rather than matrix entries, was preferred above only because it simplified the analysis;
2. The side information mentioned above is naturally available at the receiver during hypothesis testing—since any tested point in Gₑ belongs to an unique subconstellation, thereby allowing one to form X_{\textcircled{+}} by appropriate zero-padding; then, for each hypothesis, the nonzero received (i.e., observed) coordinates can be easily padded with leading or trailing zeroes, in order to form y_{\textcircled{+}} and match the standing hypothesis about the transmitted point. Thereby, when testing various χ_{\textcircled{+}} vectors—from a constellation Gₑ with a given shape-performance is determined precisely by the distances and angles between y_{\textcircled{+}} vectors; if the latter match the distances and angles between points in Gₑ (up to noise, and a scaling factor due to fading), then the shape of Gₑ is preserved, and other symmetry properties of Gₑ become relevant when they exist.
3. Equivalently, rather than calculating the Euclidean distances between multidimensional points from Gₑ in terms of vector coordinates χₖ, χ′ₖ, the decoder may (and usually does) compute them as Frobenius norms of (respective difference) matrices. (Euclidean distances between χ_{\textcircled{+}} vectors and Frobenius norms of their corresponding difference matrices are the same—with proper normalization.)
4. For example, in the space-time trellis codes from Ionescu, et al., the branches departing from, and converging to, any state use signal points from one subconstellation; when a maximum likelihood receiver tests any branch, the originating state of the branch together with the associated information bits determine a point from a precise subconstellation.

Hence, the decoder on the receiver side does, naturally, have access to the side information during hypothesis testing, and thereby benefits from shape invariance.

In summary, the fading channel, up to scaling and noise, leaves invariant the shape in the expanded signal constellation Gₑ. Although the maximum likelihood decoding for the expanded signal constellation is no longer linear, the decoding process benefit from this property nonetheless.

### B. EXAMPLE

In this section, the above results are illustrated with the expanded signal constellation in Ionescu, et al., the contents of which are incorporated herein by reference.

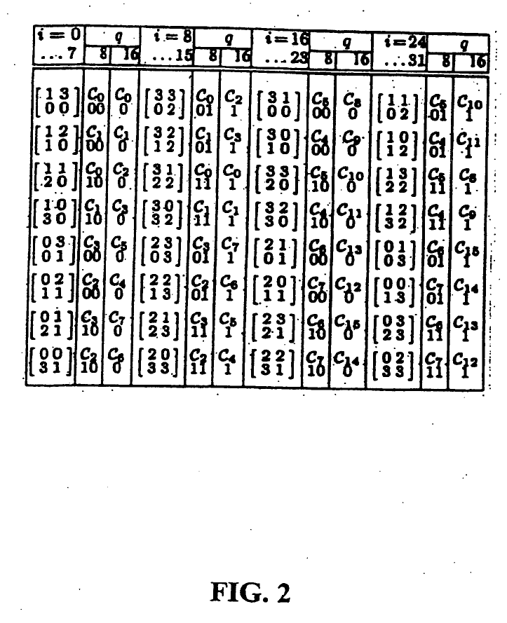

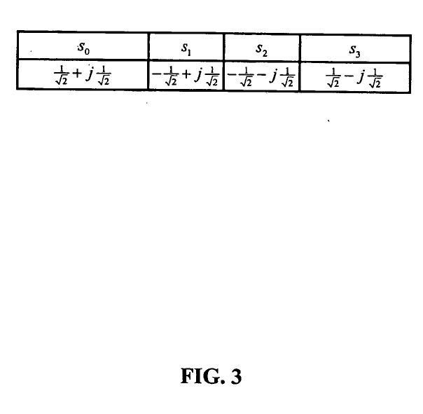

The expanded signal constellation in Ionescu, et al. over QPSK is shown in FIG. 2, which represents the 2×2 matrices Cᵢ, i=0, . . . , 31, along with relevant cosets Cₗ and corresponding uncoded bits, vs. number of states q. The entries in the codematrices in FIG. 2 are the indices of the signal points in FIG. 3, which illustrates indexing for the 4PSK constellation points. It is clear that the first 16 matrices, Cᵢ (0≦i≦15), are of the form

$$[ \begin{matrix}A & B \\ {B}^{*} & - {A}^{*}\end{matrix} ]$$

and hence can be expressed as linear combinations of the following four base matrices:

$$\frac{1}{\sqrt{2}} [ \begin{matrix}1 & 0 \\ 0 & - 1\end{matrix} ] , \frac{1}{\sqrt{2}} [ \begin{matrix}0 & 1 \\ 1 & 0\end{matrix} ] , \frac{1}{\sqrt{2}} [ \begin{matrix}i & 0 \\ 0 & i\end{matrix} ] , \frac{1}{\sqrt{2}} [ \begin{matrix}0 & - i \\ i & 0\end{matrix} ] .$$

Denote these four base matrices as βₖ, k=0,1,2,3, and the first 16 codes matrices can be represented by the linear combinations Σₖ₌₀³χₖβₖ. Similarly the other 16 code matrices, Cᵢ (16≦i≦31), are of the form

$$[ \begin{matrix}A & B \\ - {B}^{*} & {A}^{*}\end{matrix} ] ,$$

and can be represented with linear combinations of four different base matrices β′ₖ, k=0,1,2,3:

$$\frac{1}{\sqrt{2}} [ \begin{matrix}1 & 0 \\ 0 & 1\end{matrix} ] , \frac{1}{\sqrt{2}} [ \begin{matrix}0 & - 1 \\ 1 & 0\end{matrix} ] , \frac{1}{\sqrt{2}} [ \begin{matrix}i & 0 \\ 0 & - i\end{matrix} ] , \frac{1}{\sqrt{2}} [ \begin{matrix}0 & i \\ i & 0\end{matrix} ] .$$

It can be verified that βₖ's satisfy Eq. (4) and so do the β′ₖ's. However, it can be shown that the property does not necessarily hold when two matrices are from two different groups. The latter generator set is obtained from the former via β′ₖ=βₖU, k=0, . . . , 3, where

$$U = [ \begin{matrix}1 & 0 \\ 0 & - 1\end{matrix} ] .$$

Let G denote the first 16 codematrices, and Gₑ all 32 codematrices. Clearly, Gₑ=G∪GU and Gₑ is a first-tier, direct, discernible expansion. Thus, all 32 matrices can be expressed as the linear combinations of eight base matrices Σₖ₌₀³χ′ₖβₖ+Σₖ₌₀χ′ₖβ′ₖ where χₖ and χ′ₖ(k=0,1,2,3) are either 1, −1, or 0. Note that either all χₖ's or all χ′ₖ's are zeros. That is,

$$\begin{matrix}{\{ {C}_{i} \}}_{i = 0}^{31} = {\{ {C}_{i} \}}_{i = 0}^{15} ⋃ {\{ {C}_{i} \}}_{i = 16}^{31} \\ = \{ {\sum }_{k = 0}^{3} ( {χ}_{k} {β}_{k} + {χ}_{k}^{′} {β}_{k}^{′} ) \text{:} {χ}_{k} ∈ \{ - 1 , 1 \} and {χ}_{k}^{′} = 0 \} \\ ⋃ \{ {\sum }_{k = 0}^{3} ( {χ}_{k} {β}_{k} + {χ}_{k}^{′} {β}_{k}^{′} ) \text{:} {χ}_{k}^{′} ∈ \{ - 1 , 1 \} and {χ}_{k} = 0 \} .\end{matrix}$$

The space-time trellis codes in Ionescu, et al. are such that the branches departing from, and converging to, any state are all labeled by codematrices from either G or GU. As such, the side information mentioned above is accessible to the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of transmitting, from at least two antennas, a signal formed of a sequence of multidimensional points and having coding redundancy, said method comprising the steps of:
using a first set of multidimensional points, whereby each multidimensional point in said first set is capable of conveying a predefined number of bits over a specified number of channel uses, such that a signal with no coding redundancy and formed of said first set of multidimensional points exhibits a spectral efficiency of a predetermined number of bits per channel use, and wherein said first set of multidimensional points forms an initial multidimensional constellation; and
expanding said initial multidimensional constellation to create an expanded multidimensional constellation in order to enable transmission of a signal with coding redundancy without reducing the spectral efficiency of said signal, wherein the expanded multidimensional constellation is formed of a second set of multidimensional points, whereby each multidimensional point in said second set is capable of conveying a predefined number of bits over a specified number of channel uses, such that a signal with coding redundancy and formed of said second set of multidimensional points exhibits the same spectral efficiency as said signal with no coding redundancy and formed of said first set of multidimensional points, and wherein said second set of multidimensional points defines a shape in a relevant multidimensional space of the expanded multidimensional constellation, said shape being preserved, except for multiplication by a scaling factor, when subject to instantaneous realizations of multiplicative distortions during transmission of said signal over a fading channel.

2. The method of claim 1, wherein the initial multidimensional constellation is orthogonal.

3. The method of claim 1, wherein the initial multidimensional constellation is expanded by multiplying the initial multidimensional constellation by a unitary matrix U to generate the expanded multidimensional constellation.

4. The method of claim 1, wherein each of the multidimensional points forming said expanded multidimensional constellation is positioned at a distance and at an angle with respect to the other multidimensional points forming said expanded multidimensional constellation, such that a combination of the distance and angle of each multidimensional point with respect to all other multidimensional points forming said expanded multidimensional constellation makes up a set of distance and angle pairs that defines the shape of the expanded multidimensional constellation.

5. The method of claim 4, wherein said set of distance and angle pairs is the same for each constellation point within said expanded multidimensional constellation.

6. The method of claim 1, wherein each multidimensional point is represented by a matrix comprising one or more values, said one or more values representing one or more dimensions of the multidimensional point, which correspond to one or more dimensions in which said predefined number of bits associated with said multidimensional point will be transmitted.

7. The method of claim 6, wherein the one or more dimensions of the multidimensional point include one or more of space, time and frequency.

8. The method of claim 6, wherein the one or more values representing one or more dimensions are complex in nature.

9. A method of constructing a multidimensional constellation, said method comprising the steps of:
providing an initial multidimensional constellation formed of a first set of multidimensional points, each of said first set of multidimensional points capable of conveying a predefined number of bits over a specified number of channel uses, such that a first signal with no coding redundancy and formed of said first set of multidimensional points exhibits a spectral efficiency of a predetermined number of bits per channel use; and
expanding the initial multidimensional constellation to form an expanded multidimensional constellation formed of a second set of multidimensional points, each of said second set of multidimensional points capable of conveying a predefined number of bits over a specified number of channel uses, such that a second signal with coding redundancy and formed of said second set of multidimensional points exhibits the same spectral efficiency as said first signal with no coding redundancy and formed of said first set of multidimensional points, wherein said second set of multidimensional points defines a shape in a relevant multidimensional space of said expanded multidimensional constellation, said shape capable of being preserved, except for multiplication by a scaling factor, when subject to instantaneous realizations of multiplicative distortions during a transmission of said second signal over a fading channel.

10. The method of constructing a multidimensional constellation of claim 9, wherein the step of expanding the multidimensional constellation comprises multiplying the initial multidimensional constellation by a unitary matrix U to generate the expanded multidimensional constellation.

11. The method of constructing a multidimensional constellation of claim 9, wherein each of the multidimensional points in said second set of multidimensional points is positioned at a distance and at an angle with respect to the other multidimensional points in said second set of multidimensional points, such that a combination of the distance and angle of each multidimensional point with respect to all other multidimensional points in said second set of multidimensional points makes up a set of distance and angle pairs that defines the shape of the expanded multidimensional constellation.

12. The method of constructing a multidimensional constellation of claim 11, wherein said set of distance and angle pairs is the same for each multidimensional point within said second set of multidimensional points.

13. The method of constructing a multidimensional constellation of claim 9, wherein each constellation point of said initial and expanded multidimensional constellations is represented by a matrix comprising one or more values, said one or more values representing one or more dimensions of the multidimensional point, which correspond to one or more dimensions in which said predefined number of bits associated with said multidimensional point will be transmitted.

14. The method of constructing a multidimensional constellation of claim 13, wherein the one or more dimensions of the multidimensional point include one or more of space, time and frequency.

15. An apparatus for transmitting, from at least two antennas, a signal formed of a sequence of multidimensional points and having coding redundancy, said apparatus comprising:
a data source configured to provide data to be transmitted by the signal, wherein the data comprises a first set of bits capable of being conveyed by a first set of multidimensional points, whereby each multidimensional point in said first set is capable of conveying a predefined number of bits over a specified number of channel uses, such that a signal formed of said first set of multidimensional points exhibits a spectral efficiency of a predetermined number of bits per channel use, and wherein said first set of multidimensional points forms an initial multidimensional constellation;
a channel encoder configured to receive the first set of bits from the data source and to introduce coding redundancy to the first set of bits, wherein an output of the channel encoder is a second set of encoded bits, said second set being larger than said first set; and
a modulator configured to receive said second set of encoded bits and to map said second set of encoded bits to a second set of multidimensional points, whereby each multidimensional point in said second set is capable of conveying a predefined number of encoded bits over a specified number of channel uses, such that a signal formed of said second set of multidimensional points exhibits the same spectral efficiency as said signal formed of said first set of multidimensional points, wherein said second set of multidimensional points forms an expanded multidimensional constellation, said expanded multidimensional constellation having a shape in a relevant multidimensional space that is defined by said second set of multidimensional points and is preserved, except for multiplication by a scaling factor, when subject to instantaneous realizations of multiplicative distortions during transmission of said signal over a fading channel.

16. The apparatus of claim 15, wherein the shape of the initial multidimensional constellation is defined by a combination of distances and angles between multidimensional points in the first set of multidimensional points, and wherein the shape of the expanded multidimensional constellation is defined by a combination of distances and angles between multidimensional points in the second set of multidimensional points.

17. The apparatus of claim 15, wherein said expanded multidimensional constellation is created by multiplying said initial multidimensional constellation by a unitary matrix U.

18. The apparatus of claim 15, wherein each multidimensional point of the initial and expanded multidimensional constellations is represented by a matrix comprising one or more values representing one or more dimensions of the corresponding multidimensional point, said one or dimensions of the multidimensional point representing one or more dimensions in which said predefined number of bits associated with said multidimensional point will be transmitted.

19. The apparatus of claim 18, wherein the one or more dimensions of the multidimensional point include one or more of space, time and frequency.

20. The apparatus of claim 18, wherein the one or more values representing one or more dimensions are complex in nature.

21. The apparatus of claim 15, wherein the channel encoder and the modulator are one element.
